(19) United States
(12) Patent Application Publication
(10) Pub. No.: US 2006/0157389 A1
(43) Pub. Date: Jul. 20, 2006

(54) Apparatus for defibering paper or dry pulp

(75) Inventors: Robert E. Boudria, Hammond (CA); Tom Kaneb, Comwall (CA); James Randall Craig Nicklin, Manotick (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: TURBO AIR DEFIBERING

(21) Appl. No.: 11/036,385

(22) Filed: Jan. 18, 2005

(51) Int. Cl. B07B 9/00

(52) U.S. Cl. 209/21; 209/379

(57) ABSTRACT

An apparatus for extracting fibers free from contaminants in a substantially dry processing environment. Generally, the present invention provides an apparatus for extracting fibers of varying sizes and free from contaminants in a substantially dry processing environment. The apparatus for extracting fibers according to the embodiments of the present invention uses a separator system that receives a mixture of fibers and fine particulate matter, for disassociating fibres from fine particulate matter and contaminants. The separator system includes at least one screen having a specific mesh size for trapping/blocking fibres that are blown in to the separator system. The fine particulate matter pass through the screen and are collected. A sweep system is activated to physically remove any fibers pressed against the mesh, such that the freed fibers can be collected and stored in a container. The apparatus can include a material dry processing and/or defibering stage for receiving reduced paper and dry pulp material for separating out large particulate waste, and passing the defibered fibres and fine particulate contaminants to the separator system.

### FIELD OF THE INVENTION

The present invention relates generally to extracting fiber from paper and/or dry pulp. More particularly, the present invention relates to an apparatus and method for extracting fibers from paper and/or dry pulp in a substantially dry environment.

### BACKGROUND OF THE INVENTION

Various types of defibering systems for paper and pulp processing are known. Typically, in these systems, cellulose fiber, in the form of dry pulp sheets or paper, is added to large volumes of water and continuously agitated during the defibering and pulping process. In these known systems, complete defibering of dry pulp sheets or clean recycle paper fiber sheets involves lengthy process times, high energy consumption and large volumes of water.

Generally, in the presently known pulping systems, the use of a wet process environment necessitates hydraulic processing where the process water contains 4 to 16% solid matter. In this wet environment, contaminants from the cellulose material mix with the process water and impede disassociation of the cellulose fibers. Furthermore, removal of the contaminants from the process water can create substantial amounts of effluent, which raises environmental concerns.

In addition, the wet defibering and pulping processes are unable to recover many types of paper for recycling since the paper may contain wet strength additives, making the paper resistant to dissociation within the process water, or may cause other problems associated with aqueous solution processing. As a result, many grades of paper that are difficult, expensive or incapable of being processed in a wet environment are disposed of in landfills or used in non-paper related end products, such as animal bedding.

For example, paper containing wet strength additives is produced to provide durability for long term use in moist environments. As a result, wet strength paper is difficult to defiber, typically taking excessive amounts of pulping time, large amounts of chemical usage, and are typically disposed of in landfill sites. Similarly, paper containing internal or surface latex coatings are resistant to moisture and are difficult to defiber in a wet environment. Currently, these latex paper products are not easily or economically recycled using conventional wet pulp processing systems.

In addition, starches that are added to some grades of paper to provide surface characteristics that enhance paper printability, and that “close up” the paper, generate biochemical oxygen demand (BOD) materials that are passed onto effluent streams from the paper mill. These BOD materials are strictly controlled by governmental regulations, costing recycling mills heavily in their need for primary and secondary effluent treatment facilities.

De-inking facilities that remove oil-based and electronic laser type printing materials from post consumer fine stationary are subject to very high fiber losses in order to extract sufficient usable fiber from an aqueous solution. Typically these processes utilize flotation and dispersion processes, further degrading fiber characteristics by vigorous mechanical action, and low yield separation/extraction equipment. The inefficiency of these systems require that large volumes of waste inks, and good fiber, are sent to effluent treatment systems, and are finally lost to the environment.

Therefore, there is a significant need for an improved method and apparatus for addressing the shortcomings of current wet pulping and fiber extraction systems. This requirement intensifies as paper products become more moisture resistant, and as government regulations become more stringent on waste streams generated by pulp and paper mills.

It is, therefore, desirable to provide a method and apparatus for defibering paper in a dry environment in order to improve the quality of recycled pulps extracted from post consumer recycled papers, to reduce the amount of environmentally harmful waste products, and to improve the yield of good extracted fiber from fiber sources.

### SUMMARY OF THE INVENTION

It is an object of the present invention to obviate or mitigate at least one disadvantage of previous paper or dry pulp defibering apparatus and methods. In particular, it is an object of the present invention to provide an apparatus and method for dry defibering of pulp and paper, and separation of fine particulate matter from the fibre material.

In a first aspect, the present invention provides an apparatus for extracting fibres from a mixture of fibres and fine particulate matter transported in an air stream. The apparatus includes a separator system, a conveying system and a collector. The separator system has an inlet port coupled to the conduit for receiving the air stream, and at least one screen for blocking the fibers and a sweeping system for removing the fibers from the at least one screen. The fine particulate matter can be blown through the at least one screen to an outlet port. The conveying system receives the blocked fibers and transports said blocked fibers away from the separator system. The collector is coupled to the outlet port for receiving the fine particulate matter.

In an embodiment of the present aspect, there is provided a dry pulper system for receiving and reducing raw cellulose into the fibers and the fine particulate matter. The dry pulper system can generate the air stream for transporting the fibers and the fine particulate matter. The dry pulper system includes a blower for receiving and transporting the raw cellulose in the air stream through a conduit, and a dry processing cell coupled to the conduit for receiving and reducing the raw cellulose into the fibers and the fine particulate matter.

According other embodiments of the present aspect, the separator system can include a separation chamber for receiving the air stream, where the at least one screen can be integrated within a wall of the separation chamber. The separator system can include two separation chambers, where each separation chamber includes first and second screens integrated within the walls of each separation chamber. The separator system can include an exit chamber adjacent to each separation chamber for receiving the fine particulate matter, and the first and the second screens can be substantially circular in shape. The first and the second screens can be arranged substantially parallel to each other and have centres co-linear with each other.

In an aspect of the present embodiments, the sweeping system can include a sweep actuator rotatingly engaged with the centres of the first and the second screens, and first and second sweeping devices in each separation chamber coupled to the sweep actuator for removing the fibers from the first and second screens when the sweep actuator is rotated. The sweeping system can further include a fixed hub connected to the sweep actuator, rigid arms connected to the fixed hub, a pair of free-rotating bushings positioned on opposite sides of the fixed hub. Each free-rotating bushing can be in sliding engagement with the sweep actuator. The first sweeping devices are connected to one of the free-rotating bushings and the second sweeping devices are connected to the other of the free-rotating bushings. The sweeping system further includes biasing means coupled between each rigid arm and the first and second sweeping devices for biasing the first and the second sweeping devices against the first and the second screens. In yet further aspects of the present embodiment, the first and the second sweeping devices can include a blade or a brush.

In yet another embodiment of the present aspect, the conveying system is coupled to each separation chamber for receiving the fibers. The conveying system can include a fixed rotary screw coupled to each separation chamber. The fixed rotary screw can be rotated to transport the fibers to the container. The separator system can include at least two separator cells cascaded in series.

In a second aspect, the present invention provides an apparatus for extracting fibres from paper and dry pulp material. The apparatus includes a blower, a dry processing cell, a separation system, a conveying system, and a collector. The blower has a material feeder for receiving the paper and dry pulp material for driving the paper and dry pulp material through a conduit. The blower further includes a recirculation inlet for recirculating unprocessed material. The dry processing cell has a material inlet for receiving the paper and dry pulp material and for reducing the paper and dry pulp material into fibers and fine particulate matter. The fibers and fine particulate matter are blown through accept outlets, and the dry processing cell further includes a recirculation outlet for providing the unprocessed material to the recirculation inlet. The separation system has an inlet port for receiving the fibers and fine particulate matter. The separator system further includes screens for blocking the fibers and a sweeping system for removing the fibers from the screens, such that the fine particulate matter is blown through the screens to an outlet port. The conveying system receives the blocked individual fibers and transports said fibers away from the separation system. The collector is coupled to the outlet port for receiving the fine particulate matter.

In an embodiment of the present aspect, the separator system includes at least two separation chambers for receiving the mixture, each of the at least two separation chambers including first and second screens. An exit chamber is adjacent to each separation chamber for receiving the fine particulate matter, the first and second screens can be substantially circular in shape, and the first and second screens can be arranged substantially parallel to each other and have centres co-linear with each other.

According to another embodiment of the present aspect, the sweeping system can include a sweep actuator rotatingly engaged with the centres of the first and second screens, and first and second sweeping devices in each separation chamber coupled to the sweep actuator for removing the fibers from the first and second screens when the sweep actuator is rotated.

In yet another embodiment of the present aspect, the dry processing cell can include a containment means, means for creating an air flow within said containment means, at least one filtered exit port in said containment means, and at least one designed wall formation. The containment means houses paper and dry pulp material, wherein contents of said containment means have a total moisture content ranging from about 5% to about 15%. The containment means further includes a sidewall portion connected to a top portion and a bottom portion. The means for creating an air flow and the generated air flow substantially disassociates the paper and dry pulp material into the fibers. The at least one filtered exit port in the containment means has a filter means for separating and removing said fibers from the containment means. The at least one designed wall formation is connected to an interior surface of said sidewall portion of the containment means, for extending into an interior portion of the containment means for creating turbulence in the air flow.

In a third aspect, the present invention provides a method for dry extraction of fibres from a mixture of fibres and fine particulate matter. The method includes the steps of blowing raw cellulose material to a dry processing cell in an air stream; reducing the raw cellulose material into fibers and fine particulate matter in the dry processing cell; transferring the fibers and fine particulate matter in the air stream to a separator system; separating the fibers from the fine particulate matter in the separator system; and transferring the fine particulate matter in the air stream to a collector.

In an embodiment of the present aspect, the step of separating can include blocking the fibers from passing through the separator system with a screen and removing the fibers from the screen. The step of removing can include actuating a sweeping system to sweep the fibers from the screen. The step of removing can further include transporting the fibres removed from the screen away from the separator system.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a dry fiber extraction system according to an embodiment of the present invention;

FIG. 2 is a cross-sectional view of the dry processing cell of FIG. 1, taken along line C-C;

FIG. 3 is a cross-sectional view of the dry processing cell of FIG. 1, taken along line D-D;

FIG. 4 is a cross-sectional view of the separator system of FIG. 1, taken along line A-A;

FIG. 5 is a cross-sectional view of the separator system of FIG. 1, taken along line B-B;

FIG. 6 illustrates a screen sub-assembly of the separator system of FIG. 1; and,

FIG. 7 illustrates a sweeping system according to an embodiment of the present invention.

### DETAILED DESCRIPTION

Generally, the present invention provides an apparatus for extracting fibers of varying sizes and free from contaminants in a substantially dry processing environment. The apparatus for extracting fibers according to the embodiments of the present invention uses a separator system that receives a mixture of fibers and fine particulate matter, for disassociating fibres from fine particulate matter and contaminants. The separator system includes at least one screen having a specific mesh size for trapping/blocking fibres that are blown in to the cell. The fine particulate matter pass through the screen and are collected. A sweep system is activated to physically remove any fibers pressed against the mesh, such that the freed fibers can be collected and stored in a container. The apparatus can include a material dry processing and/or defibering stage for receiving reduced paper and dry pulp material for separating out large particulate waste, and passing the defibered fibres and fine particulate contaminants to the separator system.

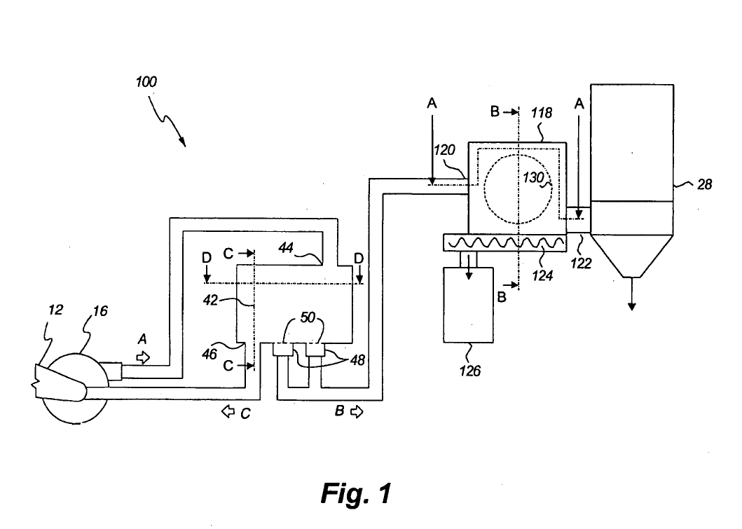

The present invention will be described in relation to the accompanying drawings, which assist in the illustration of its various features. FIG. 1 illustrates a fiber extracting system according to an embodiment of the present invention. The fiber extracting system 100 of FIG. 1 includes a material feeder 12, a circulation blower 16, a dry processing cell 42, a separator system 118 having an inlet port 120 and an outlet port 122, a conveying system 124, a storage/shipping container 126, and a collector 28. Generally, fiber extracting system 100 receives raw cellulose in dry sheet paper or dry pulp form that can be reduced in size using a paper shredder or hog, and fed in either continuous or batch amounts to the material feeder 12. The cellulose material may, for example, be in the form of dry pulp sheets, printed paper, wet strength paper, latex coated paper, mill broke, poly-coated paper or latex saturated paper. The general operation of fiber extracting system 100 is described below.

The cellulose material is supplied to the material feeder 12 where it can be combined with recirculated cellulose rejected from the pre-processing cell 42. The circulation blower 16 is capable of combining the recirculated cellulose and the raw cellulose from the paper shredder with air. The cellulose is moved in the direction of arrow A to the dry processing cell 42. The material feeder 12 and the circulation blower 16 work in combination to provide a balanced air flow in the extracting system 40 so as to convey the cellulose material mechanically and pneumatically to the top material inlet 44 of the dry processing cell 42.

Dry processing cell 42 includes a material inlet 44 connected to the output of circulation blower 16, a recirculation outlet 46 connected back to the circulation blower 16, accept outlets 48 connected to inlet port 120, and accepts screens 50 disposed within dry processing cell 42. The function of dry processing cell 42 is to reduce raw cellulose materials into fibers. An example of such an apparatus is disclosed in commonly owned U.S. Pat. No. 5,871,160, the entire contents of which are herein incorporated by reference. Dry processing cell 42 is effective for disassociating fine particulate contaminants, such as inks and fillers, from printed materials. Accepts screens can have a mesh of any suitable value for extracting a particular type of fiber. Dry processing cell 42 and blower 16 can be referred to as a dry pulping system.

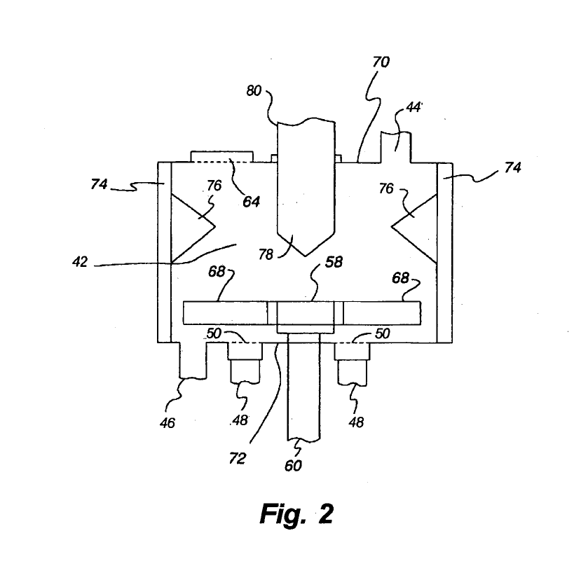

In the dry processing cell 42, the cellulose material is substantially reduced to single cellulose fibers which are filtered through accepts screens 50 to the accept outlets 48 and are moved in the direction of arrow B. Any cellulose material that has not been reduced to single fibers exits the dry processing cell 42 through the recirculation outlet 46 and is directed in the direction of arrow C to a recirculation inlet of the circulation blower 16 which recirculates the material through the system. Large matter, such as plastics or tape, are trapped inside dry processing cell 42. These materials remain in the areas of relatively low turbulence within dry processing cell 42 and are removed using a trash trap or other means (not shown in FIG. 2).

After passing through accepts screens 50, the single cellulose fibers, and any other fine particulate matter and contaminants, are propelled to inlet port 120 of the separator system 118. It is noted that fine particulate matter can include other small-sized fibers.

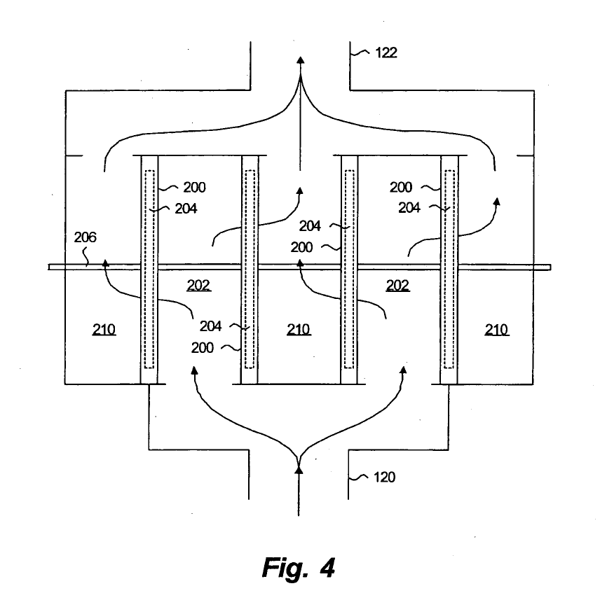

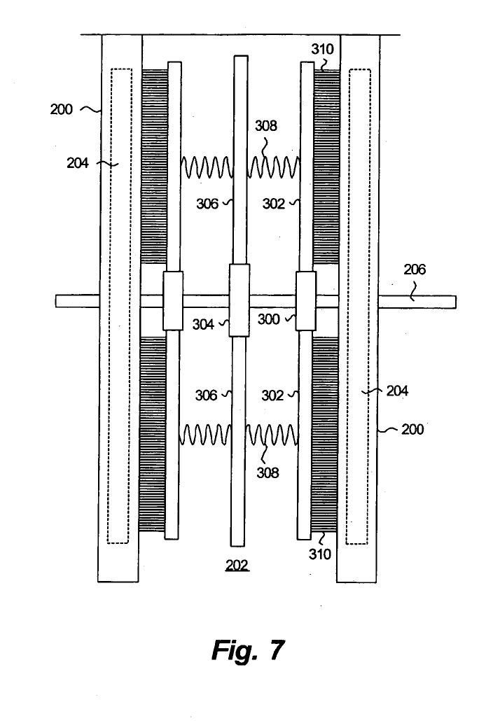

Separator system 118 separates single cellulose fibers from fine particulate contaminants or other fine particulate matter in the main air stream. More specifically, separator system 118 includes at least one swept screen 130, upon which the stream of pre-processed materials is directed. Further details of the separator system 118 and swept screen 130 are discussed with reference to FIGS. 4 to 7. The swept screen 130 then extracts the fibers from the main stream, which are then precipitated aerodynamically and gravitationally into conveying system 124, then deposited into the storage/shipping container 126 for transport to the customer. Conveying system is preferably a low attrition conveyor but can be any suitable and equivalent means for transporting the fibers away from the separator system and to the storage/shipping container 126. While not shown in FIG. 4, a sweeper system can be actuated at any time during operation to remove the fibers from the screen, which descend by gravity to the conveyor system 124. For greater efficiency, the dry processing cell 42 the sweeping system preferably operates continuously during operation of the fiber extracting system 10. Further details of a sweeping system according to an embodiment of the present invention is shown in FIG. 7.

The fine particulate contaminants, such as clays, titaniums, starches, and BOD generating materials, pass through the swept screen 130 and out of separator system 118 through outlet port 122 to collector 28. Within collector 28, the air blown from circulation blower 16 is contained to limit its dispersion, and the fine particulate matter are then collected and aerodynamically directed/precipitated to a vertical bag house filter for removal.

Further details of the components of fiber extracting system 100 are now discussed below.

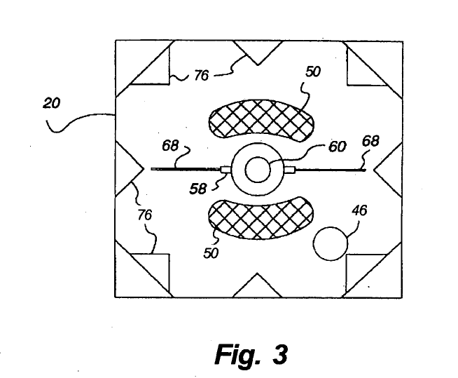

A description of the operation of dry processing cell 42 follows with reference to FIGS. 2 and 3. FIG. 2 is a cross-sectional view of dry processing cell 42 taken along line C-C, while FIG. 3 is cross-sectional view dry processing cell 42 taken along line D-D.

As shown in FIG. 2, the dry processing cell 42 is composed of a top portion 70, a bottom portion 72 and a sidewall portion 74. Furthermore, as shown in FIGS. 2 and 3, a rotating element 58 is mounted at the bottom portion 72 of the dry processing cell 42. In another embodiment, the rotating element can be mounted at the top of the dry processing cell 42. Moreover, in yet another embodiment, any means may be employed to create the turbulent controlled air flow, such as piping air into the dry processing cell 42 from an external blower.

When the cellulose material is introduced into the dry processing cell 42, it falls into a controlled turbulent air flow that directs the cellulose material toward a rotating element 58. The cellulose material enters the dry processing cell 42 via the material inlet 44. The highly turbulent air flow is created by a rotating element 58, driven by drive shaft 60. The turbulent air flow is created by rotating the blades 68 of the rotating element 58 between 500 to 5000 revolutions per minute, for example. The rotation of the rotating element 58 within the substantially closed dry processing cell 42 creates an aerodynamic vortex. In one embodiment, the rotating element 58 is shown, having two blades 68. It should be appreciated that the rotating element 58 can have four or six blades that rotate to efficiently create the turbulent air flow.

The energy and air flow created in the dry processing cell 42 can create a drying effect on the cellulose material and static electricity within the dry processing cell. To counteract these problems, sprinklers 64 can be added to the dry processing cell to mix water or other viscous fluids with the cellulose material. Generally, the moisture level introduced into the dry processing cell 42 from the sprinklers 64 ranges from 5% to 15% which leaves 85% to 95% A solid material in the dry processing cell 42. Furthermore, it should be noted that the typical moisture level within paper products ranges between 5% to 15%. Therefore, the introduction of moisture into the dry processing cell 42 is to counteract the problems mentioned above and not to create a liquid processing environment.

The turbulence in air flow created by rotation of the blades 68 is enhanced by the presence of designed wall formations such as wall baffles 76 in the form of triangular-shaped protrusions. In one embodiment, the wall baffles 76 may be fabricated in the walls of the dry processing cell 42. For example, in one embodiment the dry processing cell 42 can have an exterior wall surface that is essentially rectangular while the interior wall surface can be octagonal in shape with various baffles 76 extending into the interior portion of the dry processing cell 42. Typically, the wall baffles 76 cover about one-half of the sidewall portion 74 of the dry processing cell 42. It should be appreciated that the dimensions of the wall baffles may vary according to the dimensions of the sidewall portions 74 of interior of the dry processing cell 42. For example, in one embodiment, a dry processing cell having a sidewall portion area of 1.2 meters by 1.2 meters may have a wall baffle portion area that covers 0.6 meters by 0.6 meters of the sidewall portion area.

In an alternative embodiment, the dry processing cell 120 is essentially cubic and the wall baffles 76 can be formed in wall inserts that are removably inserted within the dry processing cell 42. In a preferred embodiment, the baffles 76 can be formed within the dry processing cell 42 by using two wall inserts. The first insert creates a non-uniform octagon within the dry processing cell 42, and the second insert creates wall baffles that protrude into the dry processing cell 42, as shown in FIG. 2. In yet another embodiment, the dry processing cell 42 can have sidewall portions 74 that are circularly shaped, and removable inserts can be used to define the interior portion of the dry processing cell 42 to introduce turbulence in the air flow circulation within the dry processing cell 42. In an alternative embodiment, a center baffle 78 that is independent from the walls of the dry processing cell 42 can be used to create turbulence in the air flow. In this regard, the center baffle 78 is capable of being suspended within the interior portion of the dry processing cell 42 by a support means 80 that is external to the dry processing cell 42.

By extending into the interior portion of the dry processing cell, the baffles 76 and 78 are used to disrupt the laminar air flow created by the rotating element 58 and to create an aerodynamic vortex into which the cellulose material is introduced. As such, the turbulent air flow created in the dry processing cell 42 by the rotating element 58 and the baffles 76 and 78 produces a scrubbing effect on the cellulose material that is capable of separating the material into single cellulose fibers. The scrubbing effect created within the dry processing cell 42 by the rotating element 58 is so intense that natural and synthetic mat-to-fiber binders, that are virtually impossible to liberate from the cellulose material in a wet processing environment, are capable of being dispersed. As shown in FIG. 2, the cellulose material falls by gravity and directed air flow from the material inlet 44 into the dry processing cell 42 and is directed by air flow into the aerodynamic vortex created by the rotating element 58. The blades 68 further reduce the size of the cellulose material and propel it toward the walls of the dry processing cell 42.

The size and shape of the dry processing cell 42 disrupts the rotation of the aerodynamic vortex and creates an area of high pressure at the cell walls and therefore causes the cellulose material to move upward. The cellulose material impacts the baffles 76 and 78 and the walls of the dry processing cell 42 as it is forced outward from the rotating element 58 and upward to the top of the dry processing cell 42. In addition to impacting the cell walls and baffles 76 and 78, the cellulose material collides with itself to aid in separation of the individual cellulose fibers. These high pressure zones, the low specific gravity of a single cellulose fiber and the poor aerodynamic shape of the single cellulose fiber reduce the ability of the single cellulose fibers to excessively impact the cell walls and become over processed. As such, the dry cell processing of the cellulose, allows the cellulose fibers to remain substantially intact and, therefore, maintain the fiber length and significantly reduce the number of destroyed fibrils.

As the cellulose material is circulated up the cell walls by the high pressure zones created within the dry processing cell 42, it encounters an area of lower turbulence and the low pressure created in the center of the dry processing cell by the rotating element 58, and the cellulose material is drawn back into the rotating element 58. Again, the cellulose material impacts and is influenced by the rotating element 58. The circulation of cellulose material within the dry processing cell 42 caused by the rotating element 58 and the wall baffles 76 and 78 causes single cellulose fibers, filler and contaminants to disassociate. This process of circulating the cellulose material is performed repeatedly until a substantial amount of the cellulose material is reduced to single cellulose fibers. As the single cellulose fibers are separated from the fiber sheets, they are removed from the dry processing cell 42 by being filtered through the accepts screens 50 or recirculated through the recirculation outlet 46 and returned to the dry processing cell 42 for further processing or filtering through the accepts screens 50. The typical processing time for substantial defibering of the cellulose material in the dry processing cell 42 is from 0.15 to 3 minutes compared to 0.5 to 2 hours in typical wet pulping processes.

The partially processed material and undispersed fiber bundles can be drawn out of the dry processing cell 42 through the recirculation outlet 46 toward the circulation blower 16 in the direction of arrow C, as shown in FIG. 1. In a preferred embodiment, the dry processing cell 42 contains one recirculation outlet 46, but it should be appreciated that more than one recirculation outlet can be added to the processing cell for recirculation purposes. The cellulose material removed from the dry processing cell 42 is circulated to the circulation blower 16 and recirculated to the material inlet 44 of the dry processing cell 42. During recirculation, the partially processed cellulose material may be mixed with unprocessed cellulose material from the material feeder 12 before it is reintroduced into the dry processing cell 42.

The single cellulose fibers and light non-cellulose materials that are liberated during the processing remain airborne and are forced through the accepts screens 50 located below the rotating element 58. In a preferred embodiment, the accepts screens 50 are located in the bottom portion 72 of the dry processing cell 42 directly below and within about 10 centimetres of the rotating element. Typically, the accepts screens 50 occupy 20% of the area of the bottom portion 72 of the dry processing cell 42, and the accepts screens 50 are crescent shaped to mirror the arc of the rotating element 58. This spatial positioning greatly decreases the tendency of binding the accepts screens 50 because the sweeping action of the rotating element 58 cause the single cellulose fibers to be filtered through the accepts screens with every one-half turn of the rotating element 58. The air flow at the accepts screens 50 directs the single cellulose fibers and light non-cellulose materials through the screens 50 and out of the dry processing cell 42 in the direction of arrow B, to the second stage separator system 118. The accepts screens 50 are used as quality control devices because they cause the cellulose material to reside within the dry processing cell 42 until it is fully processed into the single cellulose fibers and prevent undispersed fiber bundles from entering the finished single fiber stream.

While not shown in the Figures, one or more trash racks can be integrated within the bottom of dry processing cell 42, and preferably positioned in the corner areas. The trash racks actively remove waste materials such as latex matter, or other matter that cannot be broken down by dry processing cell 42 for passage through screens 50. These materials tend to accumulate in the corner areas of the cell. Removal of the accumulated waste materials by the trash racks improves overall efficiency of the system. If trash racks are not used, operation of the dry processing cell 42 can be periodically stopped to allow for manual removal of any accumulated waste materials. Those of skill in the art will understand that a variety of trash racks are commercially available, such as magnetic trash racks for removing metal, which can be integrated into the dry processing cell 42 without difficulty.

In addition to creating an air flow within the dry processing cell 42, the rotating element 58 along with the addition of aerated cellulose material from the material inlet 44 create a positive pressurization within the dry processing cell 42. More specifically during operation, the pressure in the interior portion of the dry processing cell 42 can be higher than the pressure that is external to the dry processing cell 42. Therefore, this pressurization within the dry processing cell 42 creates an area of lower pressure at the accepts screens 50. This pressure gradient at the accepts screens 50 assists in the filtering of the cellulose material through the accepts screens 50 and, therefore, removing the single cellulose fibers from the dry processing cell 42.

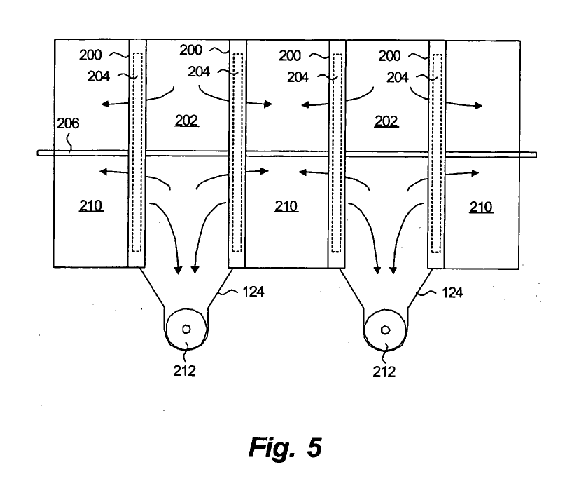

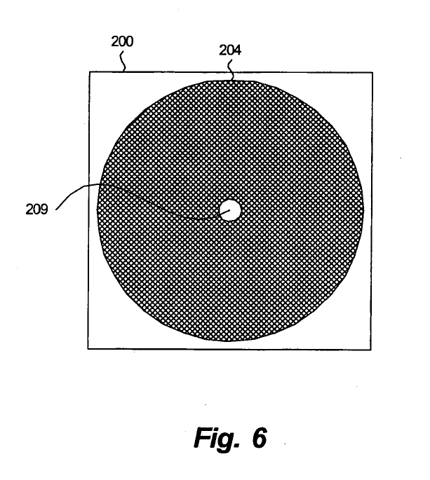

FIGS. 4 and 5 illustrate different views of second stage separator system 118 shown in FIG. 1. More specifically, FIG. 4 shows a cross-sectional view of separator system 118 taken along line A-A, while FIG. 5 shows a cross-sectional view of separator system 118 taken along line B-B. FIG. 6 illustrates a side view of screen sub assembly 200 shown in FIGS. 4 and 5. To maintain the clarity of FIG. 4 and FIG. 5, the aforementioned sweep system has been omitted. Details of the sweep system according to an embodiment of the present invention is shown in FIG. 7.

FIG. 4 shows the main air stream with arrows denoting the direction of air flow through separator system 118. The components of separator system 118 are now described with reference to FIGS. 4 and 5. Separator system 118 includes inlet port 120 for receiving the main air stream, and a series of screen sub-assemblies 200 arranged to define two separation chambers 202. More specifically, each screen sub-assembly 200 is integrated into a wall of each separation chamber 202. Preferably, each sub-assembly is arranged parallel to the other. Each separation chamber 202 receives the main air stream through its own inlet. In the presently described embodiment, the separator system 118 includes four screen sub-assemblies 200. Each screen sub-assembly 200 includes a stainless steel screen 204 having a specific mesh size to block fibers from passing through, while allowing fine particulate contaminants and air to pass through. A sweep actuator 206 extending through all the screens 204, is coupled to a sweeper system (not shown) arranged on the side of the screens 204 within separation chambers 202. The sweeper system can include a blade or brush attached to the sweep actuator 206 and in contact with screens 204, which when rotated, will move the blade or firm brush radially to remove any fibers on the screens 204. Exit chambers 210 adjacent to each separation chamber 202 receive the main air stream from the screen 204 adjacent to it, which is then directed out through its own outlet and to the outlet port 122. While the presently described separator system 118 includes two separation chambers, with two screens integrated within each chamber, the system can be configured with one separation chamber and a single integrated screen in alternate embodiments of the present invention.

As shown in FIG. 5, the conveying system 122 is arranged at the bottom portion of each separation chamber 202 to receive fibers swept from the screens 204. In the preferred embodiment, conveying of these fibers is done via a low attrition conveying system 122, such as a fixed rotary screw device 212, which transports the fibers towards the storage/shipping container 126. Those of skill in the art will understand that any suitable system for transporting the fibers can be used.

As shown in FIG. 6, screen sub-assembly 200 is a rigid frame structure having an opening corresponding in size and shape to the screen 204, for retaining the screen 204 therein. The length and height of screen sub-assembly 200 is preferably sized to produce air-flow velocities capable of sustaining a matted fiber against the screen 204. The screen 204 in the present embodiment is circular in shape, preferably constructed of stainless steel, and having a mesh range between 20 to 300 mesh. Such screens are well known in the art and commercially available. Those of skill in the art will understand that screen 204 can be configured in any shape or size, with a corresponding sweep actuator 206. In the presently preferred embodiment, each circular screen 204 is preferably arranged such that each of their centre apertures 209 are substantially co-linear to each other. This arrangement allows a sweep actuator rod to be passed through their centre apertures 209 for attachment of a sweeper system including a blade or brush for example. Those of skill in the art will understand that screens 204 can be configured in any shape, with a corresponding sweeping system configured for physically scraping the fibers from screen 204.

Hence, all pulped materials including the fibers and contaminants/fillers accepted through the accepts screens 50 of dry processing cell 42 are aerodynamically conveyed to the separation chambers 202 of the separator system 118. In each separation chamber 202, all of the pulper accepts consisting of fiber and contaminants are directed towards screen 204 where the fibers are trapped, then precipitated into the conveying system 124 to storage/shipping container 126. The fibers, which can be admitted into hermetic storage bags within storage/shipping container 126, can be vibrated to assist compaction and settling, is removed from the conveyor discharges by a gating process, and sealed in the storage container for transport to the customer.

The fine particulate matter and contaminants pass through the screens 204 to an accumulating manifold system, and then aerodynamically propelled to the vertical bag filtration system 28, also known as a dust collector. The entrained air used as a transport media is expelled through the bag media, while all contaminant residue, filters and BOD generated materials are trapped inside the bags. This residue is then extracted into an accumulating hopper by vibration, and periodically removed for disposal.

While not shown in the figures, a vibrating screen conveyor unit can be substituted for storage/shipping container 126, in accordance with an alternate embodiment of the present invention. Thus, after the single cellulose fibers are processed on the vibrating screen conveyor unit, they are bagged for storage or delivered to a pulper for further processing. The screened inks and other cellulose fibers can be collected below the vibrating screen conveyor unit.

FIG. 7 illustrates a sweeping system according to an embodiment of the present invention. The sweeping system is coupled to the sweep actuator 206 of one separation chamber 202 of separator system 118. FIG. 7 is an enlarged view of one separation chamber 202 of FIG. 4. The sweep system includes sweeping devices, such as brushes, that are biased against the surface of screens 204, and rotated by the sweep actuator 206 to physically remove fibers from the screen. In particular, the sweep system includes a free sliding bushing 300, brush supports 302 fixed to free sliding bushing 300, fixed hub 304, rigid arms 306, and biasing means 308 mounted between each rigid arm 306 and a brush support 302. Free sliding bushing 300 is in sliding engagement with sweep actuator 206, thus allowing it to slide along the axis of sweep actuator 206. Preferably, free sliding bushing 300 can rotate freely about sweep actuator 206 to minimize friction with the sweep actuator 206. Fixed hub 304 on the other hand, is rigidly fixed to sweep actuator 206, such that fixed hub 304 rotates as sweep actuator 206 rotates.

Biasing means 308 biases bristles 310, attached to brush supports 302, against screen 204. While biasing means 308 is shown as a spring in the present example, those of skill in the art will understand that any equivalent biasing component can be used. The softness and length of bristles 310 can be optimized to achieve an overall firmness that is suitable for removing fibers from screen 204. Furthermore, the strength of biasing means 308 can be selected to apply more or less biasing force to brush supports 302. The biasing means 308 transfers rotational movement of rigid arms 306 to brush supports 302, such that brush supports 302 and rigid arms 306 rotate at the same time. Therefore, as sweep actuator 206 rotates, fixed hub 304 and rigid arms 306 rotate about the axis of sweep actuator 206. The biasing action of biasing means 308 ensures that the bristles 310 effectively remove fibres from screen 204. An additional advantage provided by biasing means 308 is the constant application of bristles 310 against screens 204. As the bristles 310 wear out and shorten due to wear, biasing means 308 compensates by pushing shortened bristles against the screens 204. Hence, the fiber extraction system 100 can operate continuously for longer periods of time before the brushes must be replaced.

While FIG. 7 shows two brush supports 302 biased against each screen 204, any number of brush supports 302 can be biased against each screen 204. Accordingly, the number of brush supports 302, and the rate of rotation of sweep actuator 206 can be optimized for any specific rate of air flow through separator system 118. Instead of brushes, rigid or semi-rigid blades can be biased against screens 204 to remove the fibres. Such blades can be constructed of plastic or metal.

According to an alternate embodiment of the present invention, the separator system 118 can include multiple individual separator systems, called separator cells. Each separator cell can be configured and can be serially cascaded, such that the air from the main stream exiting the outlet port 122 of a first separator cell 118 is input to the inlet port 120 of the subsequent separator cell 118. Naturally, the mesh of each successive separator cell 118 should be progressively finer, such that particulate materials can be effectively binned according to particulate size. Furthermore, additional stages decreases the volume of final particulate matter that is collected by collector 28.

While the separation system 118 has been described as having two separation chambers 202, alternate configurations of the separation system 118 can have a single chamber, or more than two chambers. Furthermore, each chamber can have one screen sub-assembly 200 instead of two screen sub-assemblies.

The foregoing discussion of the invention has been presented for purposes of illustration and description. Further, the description is not intended to limit the invention to the form disclosed herein. Consequently, variation and modification commensurate with the above teachings, within the skill and knowledge of the relevant art, are within the scope of the present invention. The embodiment described herein and above is further intended to explain the best mode presently known of practicing the invention and to enable others skilled in the art to utilize the invention as such, or in other embodiments, and with the various modifications required by their particular application or uses of the invention. It is intended that the appended claims be construed to include alternative embodiments to the extent permitted by the prior art.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An apparatus for extracting fibres from a mixture of fibres and fine particulate matter transported in an air stream, comprising:
a separator system having an inlet port coupled to the conduit for receiving the air stream, the separator system having at least one screen for blocking the fibers and a sweeping system for removing the fibers from the at least one screen, the fine particulate matter being blown through the at least one screen to an outlet port;
a conveying system for receiving the blocked fibers and for transporting said blocked fibers away from the separator system;
a collector coupled to the outlet port for receiving the fine particulate matter.

2. The apparatus of claim 1, further including a dry pulper system for receiving and reducing raw cellulose into the fibers and the fine particulate matter, the dry pulper system generating the air stream for transporting the fibers and the fine particulate matter.

3. The apparatus of claim 2, wherein the dry pulper system includes a
blower for receiving and transporting the raw cellulose in the air stream through a conduit, and
a dry processing cell coupled to the conduit for receiving and reducing the raw cellulose into the fibers and the fine particulate matter.

4. The apparatus of claim 1, wherein the separator system includes a separation chamber for receiving the air stream, the at least one screen being integrated within a wall of the separation chamber.

5. The apparatus of claim 1, wherein the separator system includes two separation chambers, each separation chamber including first and second screens integrated within the walls of each separation chamber.

6. The apparatus of claim 5, wherein the separator system includes an exit chamber adjacent to each separation chamber for receiving the fine particulate matter.

7. The apparatus of claim 5, wherein the first and the second screens are substantially circular in shape.

8. The apparatus of claim 7, wherein the first and the second screens are arranged substantially parallel to each other and have centres co-linear with each other.

9. The apparatus of claim 8, wherein the sweeping system includes
a sweep actuator rotatingly engaged with the centres of the first and the second screens, and
first and second sweeping devices in each separation chamber coupled to the sweep actuator for removing the fibers from the first and second screens when the sweep actuator is rotated.

10. The apparatus of claim 9, wherein the sweeping system further includes
a fixed hub connected to the sweep actuator,
rigid arms connected to the fixed hub,
a pair of free-rotating bushings positioned on opposite sides of the fixed hub, each free-rotating bushing in sliding engagement with the sweep actuator, the first sweeping devices being connected to one of the free-rotating bushings and the second sweeping devices being connected to the other of the free-rotating bushings, and
biasing means coupled between each rigid arm and the first and second sweeping devices for biasing the first and the second sweeping devices against the first and the second screens.

11. The apparatus of claim 10, wherein the first and the second sweeping devices includes a blade.

12. The apparatus of claim 10, wherein the first and the second sweeping devices includes a brush.

13. The apparatus of claim 1, wherein the conveying system is coupled to each separation chamber for receiving the fibers.

14. The apparatus of claim 13, wherein the conveying system includes a fixed rotary screw coupled to each separation chamber, the fixed rotary screw being rotated to transport the fibers to the container.

15. The apparatus of claim 13, wherein the separator system includes at least two separator cells cascaded in series.

16. An apparatus for extracting fibres from paper and dry pulp material comprising:
a blower having a material feeder for receiving the paper and dry pulp material for driving the paper and dry pulp material through a conduit, the blower having a recirculation inlet for recirculating unprocessed material;
a dry processing cell having a material inlet for receiving the paper and dry pulp material and for reducing the paper and dry pulp material into fibers and fine particulate matter, the fibers and fine particulate matter being blown through accept outlets, the dry processing cell having a recirculation outlet for providing the unprocessed material to the recirculation inlet;
a separation system having an inlet port for receiving the fibers and fine particulate matter, the separator system having screens for blocking the fibers and a sweeping system for removing the fibers from the screens, the fine particulate matter being blown through the screens to an outlet port;
a conveying system for receiving the blocked individual fibers and for transporting said fibers away from the separation system;
a collector coupled to the outlet port for receiving the fine particulate matter.

17. The apparatus of claim 16, wherein the separator system includes at least two separation chambers for receiving the mixture, each of the at least two separation chambers including first and second screens.

18. The apparatus of claim 17, wherein an exit chamber is adjacent to each separation chamber for receiving the fine particulate matter.

19. The apparatus of claim 17, wherein the first and second screens are substantially circular in shape.

20. The apparatus of claim 18, wherein the first and second screens are arranged substantially parallel to each other and have centres co-linear with each other.

21. The apparatus of claim 20, wherein the sweeping system includes
a sweep actuator rotatingly engaged with the centres of the first and second screens, and
first and second sweeping devices in each separation chamber coupled to the sweep actuator for removing the fibers from the first and second screens when the sweep actuator is rotated.

22. The apparatus of claim 16, wherein the dry processing cell includes
a containment means for housing paper and dry pulp material wherein contents of said containment means have a total moisture content ranging from about 5% to about 15%, said containment means having a sidewall portion connected to a top portion and a bottom portion;
means for creating an air flow within said containment means, wherein said means for creating an air flow and said air flow generated by said means for creating substantially disassociates said paper and dry pulp material into the fibers;
at least one filtered exit port in said containment means having a filter means for separating and removing said fibers from said containment means; and
at least one designed wall formation connected to an interior surface of said sidewall portion of said containment means for extending into an interior portion of said containment means for creating turbulence in said air flow.

23. A method for dry extraction of fibres from a mixture of fibres and fine particulate matter, comprising:
a) blowing raw cellulose material to a dry processing cell in an air stream;
b) reducing the raw cellulose material into fibers and fine particulate matter in the dry processing cell;
c) transferring the fibers and fine particulate matter in the air stream to a separator system;
d) separating the fibers from the fine particulate matter in the separator system; and
e) transferring the fine particulate matter in the air stream to a collector.

24. The method of claim 23, wherein the step of separating includes blocking the fibers from passing through the separator system with a screen.

25. The method of claim 24, wherein the step of separating includes removing the fibers from the screen.

26. The method of claim 25, wherein the step of removing includes actuating a sweeping system to sweep the fibers from the screen.

27. The method of claim 25, wherein the step of removing includes transporting the fibres removed from the screen away from the separator system.
